(19) United States
(12) Patent Application Publication
(10) Pub. No.: US 2026/0322883 A1
(43) Pub. Date: Oct. 15, 2026

(54) METHOD AND APPARATUS FOR CONTROLLING INTERNET OF THINGS DEVICE, COMMUNICATION DEVICE, AND READABLE STORAGE MEDIUM

(71) Applicant: VIVO MOBILE COMMUNICATION CO., LTD., Dongguan (CN)

(72) Inventors: Huan LI, Dongguan (CN); Xiaowan KE, Dongguan (CN)

(73) Assignee: VIVO MOBILE COMMUNICATION CO., LTD., Dongguan (CN)

(21) Appl. No.: 19/464,595

(22) Filed: Jan. 29, 2026

Related U.S. Application Data
(63) Continuation of application No. PCT/CN2024/108912, filed on Jul. 31, 2024.

(30) Foreign Application Priority Data
Aug. 2, 2023 (CN) 202310970189.6

(51) Int. Cl. H04L 67/125; G16Y 40/30

(52) U.S. Cl. CPC H04L 67/125; G16Y 40/30

(57) ABSTRACT

A method and an apparatus for controlling an Internet of Things device, a communication device, and a non-transitory computer-readable storage medium are provided. The method for controlling an Internet of Things device includes: receiving, by a first network element, a first control request message. The first control request message is used for requesting to perform first control on the Internet of Things device. The method further includes sending, by the first network element, first information. The first information is used for at least one of the following: triggering obtaining identifier information of the Internet of Things device, or triggering performing the first control on the Internet of Things device.

### CROSS-REFERENCE TO RELATED APPLICATIONS

This application is a continuation of International Application No. PCT/CN2024/108912, filed on Jul. 31, 2024, which claims the priority of Chinese Patent Application No. 202310970189.6, filed in China on Aug. 2, 2023. The entire contents of each of the above-referenced applications are expressly incorporated herein by reference.

### TECHNICAL FIELD

This application belongs to the field of communication technologies, and specifically, relates to a method and an apparatus for controlling an Internet of Things device, a communication device, and a readable storage medium.

### BACKGROUND

Radio Frequency Identification (RFID) is a technology using a backscatter communication technology, and supports data transmission between an electronic tag and a reader.

In the RFID technology, limited by a feature of obtaining energy by an Internet of Things device, the Internet of Things device can work only when being close to a read/write device. Currently, the 3GPP standard organization is discussing ambient Internet of Things devices, and further discusses how to enable an Internet of Things server to communicate with Internet of Things devices through a 3GPP network, for example, to control the Internet of Things devices.

### SUMMARY

Embodiments of this application provide a method and an apparatus for controlling an Internet of Things device, a communication device, and a readable storage medium, to control an Internet of Things device by using a network element in a network, thereby improving communication performance of the Internet of Things device.

According to a first aspect, a method for controlling an Internet of Things device is provided. The method includes: receiving, by a first network element, a first control request message, where the first control request message is used for requesting to perform first control on the Internet of Things device; and sending, by the first network element, first information, where the first information is used for at least one of the following: triggering obtaining identifier information of the Internet of Things device, and triggering performing the first control on the Internet of Things device.

According to a second aspect, a method for controlling an Internet of Things device is provided. The method includes: receiving, by a read/write device, first information; and performing, by the read/write device, a first operation according to the first information, where the first operation includes at least one of the following: obtaining identifier information of the Internet of Things device; and performing first control on the Internet of Things device.

According to a third aspect, a method for controlling an Internet of Things device is provided. The method includes: receiving, by the Internet of Things device, first device control information from a read/write device; and performing, by the Internet of Things device, a second operation according to the first device control information, where the performing a second operation includes at least one of the following: sending identifier information of the Internet of Things device; and performing an operation corresponding to first control.

According to a fourth aspect, an apparatus for controlling an Internet of Things device is provided. The apparatus includes: a receiving module and a sending module, where the receiving module is configured to receive a first control request message, where the first control request message is used for requesting to perform first control on the Internet of Things device; and the sending module is configured to send first information, where the first information is used for at least one of the following: triggering obtaining identifier information of the Internet of Things device, and triggering performing the first control on the Internet of Things device.

According to a fifth aspect, an apparatus for controlling an Internet of Things device is provided. The apparatus includes: a receiving module and an execution module, where the receiving module is configured to receive first information; and the execution module is configured to perform a first operation according to the first information, where the first operation includes at least one of the following: obtaining identifier information of the Internet of Things device; and performing first control on the Internet of Things device.

According to a sixth aspect, an apparatus for controlling an Internet of Things device is provided. The apparatus includes: a receiving module and an execution module, where the receiving module is configured to receive first device control information from a read/write device; and the execution module is configured to perform a second operation according to the first device control information received by the receiving module, where the performing a second operation includes at least one of the following: sending identifier information of the Internet of Things device; and performing an operation corresponding to first control.

According to a seventh aspect, a terminal is provided. The terminal includes a processor and a memory, the memory stores a program or instructions runnable on the processor, and the program or instructions, when executed by the processor, implement the steps of the method according to the second aspect or the third aspect.

According to an eighth aspect, a terminal is provided, including a processor and a communication interface. The communication interface is configured to receive first information; and the processor is configured to perform a first operation according to the first information, where the first operation includes at least one of the following: obtaining identifier information of an Internet of Things device; and performing first control on the Internet of Things device; or the communication interface is configured to receive first device control information from a read/write device; and the processor is configured to perform a second operation according to the first device control information, where the performing a second operation includes at least one of the following: sending identifier information of an Internet of Things device; and performing an operation corresponding to first control.

According to a ninth aspect, a network side device is provided. The network side device includes a processor and a memory. The memory stores a program or instructions runnable on the processor. The program or instructions, when executed by the processor, implement the steps of the method according to the first aspect or the second aspect.

According to a tenth aspect, a network side device is provided, including a processor and a communication interface. The communication interface is configured to receive a first control request message, where the first control request message is configured for performing first control on an Internet of Things device; and the processor is configured to send first information, where the first information is used for at least one of the following: triggering obtaining identifier information of the Internet of Things device, and triggering performing the first control on the Internet of Things device; or the communication interface is configured to receive the first information; and the processor is configured to perform a first operation according to the first information, where the first operation includes at least one of the following: obtaining identifier information of the Internet of Things device; and performing first control on the Internet of Things device.

According to an eleventh aspect, a readable storage medium is provided. The readable storage medium stores a program or instructions, and the program or instructions, when executed by a processor, implement the steps of the method according to the first aspect, or implement the steps of the method according to the second aspect, or implement the steps of the method according to the third aspect.

According to a twelfth aspect, a wireless communication system is provided, including: a terminal and a network side device. The terminal may be configured to perform the steps of the method according to the second aspect or the third aspect, and the network side device may be configured to perform the steps of the method according to the first aspect or the second aspect.

According to a thirteenth aspect, a chip is provided. The chip includes a processor and a communication interface. The communication interface is coupled to the processor, and the processor is configured to run a program or instructions to implement the method according to the first aspect, or implement the method according to the second aspect, or implement the method according to the third aspect.

According to a fourteenth aspect, a computer program/program product is provided. The computer program/program product is stored in a storage medium, and the computer program/program product, when executed by at least one processor, implements the steps of the method according to the first aspect, or implements the steps of the method according to the second aspect, or implements the steps of the method according to the third aspect.

In the embodiments of this application, after receiving a first control request message, a first network element sends first information according to the first control request message, where the first control request message is used for requesting to perform first control on an Internet of Things device, and a function of the first information includes at least one of the following: triggering obtaining identifier information of the Internet of Things device, and triggering performing the first control on the Internet of Things device. In this way, through the method, in a case that communication with the Internet of Things device is required, the Internet of Things device may be controlled by using the first network element, thereby improving communication performance of the Internet of Things device.

### BRIEF DESCRIPTION OF THE DRAWINGS

FIG. 1 is a block diagram of a wireless communication system according to an embodiment of this application;

FIG. 2 is a schematic flowchart 1 of a method for controlling an Internet of Things device according to an embodiment of this application;

FIG. 3 is a schematic flowchart 2 of a method for controlling an Internet of Things device according to an embodiment of this application;

FIG. 4 is a schematic flowchart 3 of a method for controlling an Internet of Things device according to an embodiment of this application;

FIG. 5 is a schematic flowchart 4 of a method for controlling an Internet of Things device according to an embodiment of this application;

FIG. 6 is a schematic flowchart 5 of a method for controlling an Internet of Things device according to an embodiment of this application;

FIG. 7 is a schematic flowchart 6 of a method for controlling an Internet of Things device according to an embodiment of this application;

FIG. 8 is a schematic structural diagram 1 of an apparatus for controlling an Internet of Things device according to an embodiment of this application;

FIG. 9 is a schematic structural diagram 2 of an apparatus for controlling an Internet of Things device according to an embodiment of this application;

FIG. 10 is a schematic structural diagram 3 of an apparatus for controlling an Internet of Things device according to an embodiment of this application;

FIG. 11 is a schematic structural diagram of a communication device according to an embodiment of this application;

FIG. 12 is a schematic diagram of a hardware structure of a terminal according to an embodiment of this application;

FIG. 13 is a schematic diagram 1 of a hardware structure of a network side device according to an embodiment of this application; and

FIG. 14 is a schematic diagram 2 of a hardware structure of a network side device according to an embodiment of this application.

### DETAILED DESCRIPTION

The following clearly describes the technical solutions in embodiments of this application with reference to the accompanying drawings in the embodiments of this application. Clearly, the described embodiments are some but not all of the embodiments of this application. Based on the embodiments of this application, all other embodiments obtained by a person of ordinary skill in the art should fall within the protection scope of this application.

The terms “first”, “second”, and the like in this application are intended to distinguish between similar objects, but are not necessarily used to describe a specific order or sequence. It should be understood that the terms used in such a way are exchangeable in a proper case, so that the embodiments of this application described herein can be implemented in an order other than the order shown or described herein. In addition, objects distinguished by “first”, “second”, and the like are generally of one type, and a quantity of objects is not limited. For example, there may be one or more first objects. In addition, “or” in this application represents at least one of connected objects. For example, “A or B” covers three solutions, that is, solution 1: including A and excluding B; solution 2: including B and excluding A; and solution 3: including both A and B. The character “/” generally indicates an “or” relationship between the associated objects.

The term “indication” in this application may be a direct indication (or an explicit indication), or may be an indirect indication (or an implicit indication). The direct indication may be understood as that a transmitter explicitly notifies a receiver of content of a sent indication such as specific information, an operation that needs to be performed, or a request result. The indirect indication may be understood as that a receiver determines corresponding information according to an indication sent by a transmitter, or performs determining and determines an operation that needs to be performed or a request result according to a determining result.

It should be noted that technologies described in the embodiments of this application are not limited to a Long Term Evolution (LTE)/LTE-Advanced (LTE-A) system, and may be further applied to another wireless communication system such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), or another system. The terms “system” and “network” in the embodiments of this application are often used interchangeably. The described technology may be used in the foregoing system and radio technology, or may be used in another system and radio technology. The following describes a New Radio (NR) system as an example, and NR terms are used in most of the following descriptions. However, these technologies may also be used in systems other than the NR system, for example, a 6th Generation (6G) communication system.

FIG. 1 is a block diagram of a wireless communication system to which an embodiment of this application is applicable. The wireless communication system includes a terminal 11 and a network side device 12. The terminal device 11 may be a terminal side device such as a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), a ship device, a Pedestrian User Equipment (PUE), a smart home (a home device having a wireless communication function, such as a refrigerator, a television, a washing machine, furniture, or the like), a game console, a Personal Computer (PC), a teller machine, or a self-service machine. The wearable device includes: a smart watch, a smart bracelet, a smart headset, smart glasses, smart jewelry (a smart bangle, a smart chain bracelet, a smart ring, a smart necklace, a smart ankle bangle, a smart anklet, or the like), a smart wristband, smart clothing, and the like. The vehicle user equipment may be referred to as an in-vehicle terminal, an in-vehicle controller, an in-vehicle module, an in-vehicle component, an in-vehicle chip, an in-vehicle unit, or the like. It needs to be noted that in the embodiments of this application, a specific type of the terminal 11 is not limited. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another appropriate term in the art. Provided that the same technical effects are achieved, the base station is not limited to a specific technology vocabulary. It needs to be noted that the base station in the NR system is used only as an example for description in the embodiments of this application, and a specific type of the base station is not limited.

The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It needs to be noted that the core network device in the NR system is used only as an example for description in the embodiments of this application, and a specific type of the core network device is not limited.

The following provides an explanation of the proprietary terms used in the embodiments of this application.

### 1. Ambient-Enabled Internet of Things (AIoT)

Ambient IoT is a new 3GPP IoT technology. An Ambient IoT device has ultra-low complexity and ultra-low power consumption.

The Ambient IoT, also referred to as Ambient power-enabled IoT, is an IoT service, where an IoT device obtains energy from an environment through energy harvesting, reducing a requirement for replacing a battery or charging. An energy source for energy harvesting includes radio waves, light, motion, heat, or another suitable energy source.

Energy of an Ambient IoT device comes from energy harvesting. For energy storage, the device may have the following features:
having no battery and no energy storage, and relying on an external energy source; or
having a limited energy storage capability, for example, storing energy by using a capacitor.

The Ambient IoT device may be classified based on an energy source, an energy storage capability, passive or active transmission, or the like. It needs to be noted that the Ambient IoT may include Passive IoT.

In an overall architecture of Ambient IoT access to a 3GPP communication network, a UE or a RAN may be used as a reader to obtain data from the Ambient IoT device and transmit the data to an Ambient IoT application server.

### 2. Internet of Things Terminal

The Internet of Things terminal generally refers to a terminal device used in some specific scenarios or specific services. An Internet of Things device may be optimized for specific requirements of the services and applications that need to be performed (for example, smart homes/cities, smart utilities, e-health, and smart wearable devices).

### 3. Radio Frequency Identification Tag

An RFID tag may be considered as an ambient Internet of Things terminal. An RFID reader may read information from the RFID tag by using a radio wave.

Radio frequency identification technologies may further be classified into three types: active, passive, and semi-active. A passive tag may also be referred to as passive IoT, that is, a passive Internet of Things device. A communication manner of the RFID device may be performing signal transmission based on Backscattering (BSC) RF signals. In some alternative embodiments, some RFID devices also have an active signal generation capability. Because energy of the RFID device may be sourced from an environment, for example, a radio signal, solar, thermal energy, wind energy, or kinetic energy, the RFID device may also be considered as an AIoT device.

### 4. Read/Write Device

The read/write device is a device that reads information of a low power device, and, may further write information into a low power device. The read/write device may be understood as a device that communicates with a low power device, or act as an access point for a low power device to access a wireless communication system. The read/write device may be a terminal, a base station, or a device having a read/write function, for example, a reader, which is not specifically limited herein.

A 5G system includes a terminal, an access network, and a core network. The 5G system provides a data channel between a terminal and a data network, so that the terminal can access services in the data network. The terminal accesses a 5G core network. The 5G core network may perform access control and authentication on the terminal and provide a communication service to the terminal according to an identifier of the terminal and corresponding subscription data.

Currently, in the RFID technology, a reader and a tag need to be close enough to each other to work. The 3GPP standard organization is discussing how to enable an Internet of Things server to communicate with an ambient Internet of Things devices by using a 3GPP network, for example, to control the ambient Internet of Things devices.

In this embodiment of this application, after a first network element in a communication network receives a first control request message, the first network element sends first information. A function of the first information includes at least one of the following: triggering obtaining identifier information of the Internet of Things device, and triggering performing first control on the Internet of Things device. In this way, through the method, in a case that the Internet of Things device needs to be controlled, the first information may be sent by using the first network element, to trigger obtaining the identifier information of the Internet of Things device or trigger performing the first control on the Internet of Things device, so that an Internet of Things app can control the Internet of Things device by using the first network element in the network. In this way, the first network element may assist in controlling the Internet of Things device, thereby improving coverage of a network architecture including the Internet of Things device, and supporting large-scale cellular networking deployment, massive Internet of Things devices, and seamless coverage.

The method for controlling an Internet of Things device provided in the embodiments of this application is described below in detail by using some embodiments and application scenarios thereof with reference to the accompanying drawings.

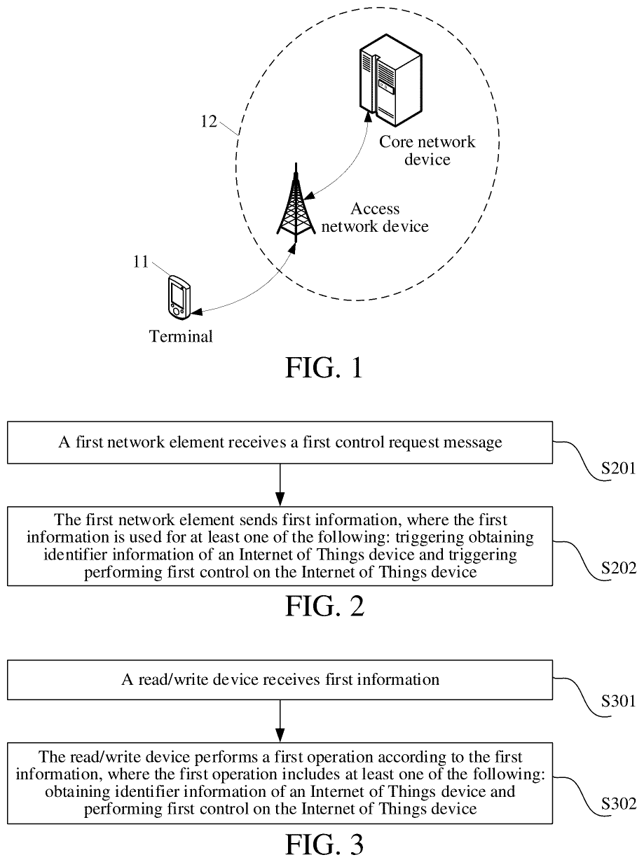

FIG. 2 is a flowchart of a method for controlling an Internet of Things device according to an embodiment of this application. As shown in FIG. 2, the method may include the following step S201 and step S202.

Step S201: A first network element receives a first control request message.

The first control request message is used for requesting to perform first control on the Internet of Things device.

In this embodiment of this application, the first network element may be an Access and Mobility Management Function (AMF)

In this embodiment of this application, the Internet of Things device may be an ambient Internet of Things device, and the ambient Internet of Things device may also be referred to as an ambient-enabled Internet of Things device (that is, an AIoT device).

In this embodiment of this application, the first control request message includes at least one of the following:
area information of an area in which the Internet of Things device is located;
a device service identifier of the Internet of Things device;
a device group service identifier corresponding to the Internet of Things device;
a control type corresponding to the first control;
a cycle of the first control; and
a frequency of the first control.

For example, the area information describes an area in which the AIoT device that needs to be controlled is located.

For example, the device service identifier is an identifier used for identifying an AIoT device in an AIoT App, that is, indicating that a target AIoT device performs a control operation.

For example, the device group service identifier is used for identifying a group of AIoT devices in the AIoT App. The AIoT device group may be preset by an operator and the AIoT App, and may also be used for describing a type of AIoT devices, for example, an inventory type, a sensing type, a positioning type, and a control type.

For example, the control type includes at least one of the following: inventory, activation, deactivation, read, write, pushing data, or deleting data.

For example, the cycle of the first control or the frequency of the first control may be carried in a Next Generation Application Protocol (NGAP) message or a Non Access Stratum (NAS) message, to instruct the read/write device to repeatedly send the device control information to the AIoT device according to the cycle or the frequency.

In this embodiment of this application, the first network element may receive at least one of the area information of the Internet of Things device, the device service identifier, the device group service identifier, the control type, a cycle of a device control command, and a frequency of a device control command sent by the Internet of Things server, and send first information according to the above, thereby accurately performing a corresponding control operation on the Internet of Things device that needs to perform communication.

In this embodiment of this application, the first network element may receive the first control request message from an AIoT server. For example, using an example in which the first network element is an AMF, the AIoT App may send the first control request message to the AMF in one of the following manners:
sending the control request message to the AMF by using a Network Exposure Function (NEF);
sending the control request message to the AMF by using the NEF and a Unified Data Management (UDM) network element; and
sending the control request message to the AMF by using the NEF and an AIoT Network Function NF).

In this embodiment of this application, in a case that the first control request message is sent, the first control request message is authorized by using the NEF. For example, the NEF determines whether to allow the AIoT App to make a control request and whether to allow the AIoT App to perform a control operation on the AIoT device in the control request message.

It needs to be noted that when the AIoT control request message is forwarded by an intermediate network element (for example, an NEF or another NF), a parameter in the AIoT control request message may change. For example, a value of the area parameter sent by the AIoT App may be a geographical location, and a value of the area parameter received by the AMF may be location information in an operator network. The AIoT App sends an AIoT device service identifier parameter, and the AMF may receive an identifier parameter of the AIoT device in the operator network.

In this embodiment of this application, the first control includes at least one of the following: inventory, read, write, data transmission, push, activation, deactivation, and data deletion.

It needs to be noted that the first control may be other control, which is not limited in this embodiment of this application.

In embodiments of this application, the first network element may control performing of at least one of inventory, read, write, data transmission, push, activation, deactivation, and data deletion on the Internet of Things device, thereby improving efficiency of an operation, such as inventory and data reading/writing, performed by the Internet of Things device.

Step S202: The first network element sends first information, where the first information is used for at least one of the following:
triggering obtaining identifier information of the Internet of Things device, and
triggering performing the first control on the Internet of Things device.

In this embodiment of this application, the first information includes at least one of the following:
device control information;
a device control type;
device identifier information of the Internet of Things device;
a sending cycle of the device control information;
a sending frequency of the device control information; and
a device control transaction identifier, where the device control transaction identifier is used for marking a device control process corresponding to the first information, where
the device control information is used for at least one of the following:
obtaining the identifier information of the Internet of Things device; and
performing the first control on the Internet of Things device.

For example, the device control type (namely, an AIoT command type) corresponds to the control type, and includes one of the following: inventory, activation, deactivation, read, write, pushing data, and deleting data.

For example, the device control information may be a device control command, and may be represented as an AIoT NAS command. An AIoT control request command encapsulated by a protocol stack (for example, the NAS) between the AIoT device and the AMF may include at least one of an AIoT command type and AIoT command content.

For example, the AIoT command content may include at least one of the following: a security parameter, a read parameter, a write parameter, and write parameter content corresponding to the AIoT command, and an AIoT command cycle/frequency.

Some or all of the parameters in the device control information may be encrypted by using a preconfigured key, a key negotiated with the AIoT device, or a key negotiated with an AIoT service provider. In some embodiments, an encrypted parameter is invisible to the reader. For example, the reader cannot decrypt the encrypted parameter.

For example, the sending cycle of the device control information or the sending frequency of the device control information, namely, the AIoT command cycle/frequency, may be carried in an NGAP or a NAS message, so that the reader repeatedly sends an AIoT NAS command part to the AIoT device according to the cycle or the frequency.

For example, the device identifier information, for example, AIoT device identifier information, is used for identifying one AIoT device or a group of AIoT devices in the AMF and the reader. The device identifier information may include at least one of the following: an AIoT device Identifier (namely, an AIoT device ID), and an AIoT device group Identifier (namely, an AIoT device group ID).

It needs to be noted that the AIoT device ID and the AIoT device group ID respectively correspond to an AIoT device service identifier and an AIoT device group service identifier. The AIoT device ID and the AIoT device group ID may be the same or different. In a case that the AIoT device ID and the AIoT device group ID are different, the AMF may determine the AIoT device identifier information according to a stored relationship between the two and the AIoT device service identifier or the AIoT device group service identifier.

In some embodiments, the AIoT device group ID may be a part of the AIoT device ID. The AIoT device type may also be a part of the AIoT device ID.

In some embodiments, the AIoT device identifier information may be allocated by the read/write device to the AIoT device.

In a possible implementation, the AMF may determine the AIoT device identifier information according to the AIoT device service identifier. The AMF sends a control request message to the reader, and the control request message includes the AIoT device identifier information.

In another possible implementation, the AMF sends the control request message to the reader, where the AIoT device service identifier is null. The reader sends the control request message to the AIoT device, allocates an AIoT device ID to an AIoT device after receiving a response from the AIoT device, and sends the AIoT device ID to the AMF.

It needs to be noted that the AIoT device service identifier may be null. This may occur when the AMF sends the control request message to the AIoT device for the first time, because the AMF does not know how to mark the AIoT device on the reader. In some alternative embodiments, the AMF does not know which AIoT devices exist under coverage of the reader. In some other embodiments, a request of the AIoT App is an inventory request, and an objective is to obtain the identifier information of the AIoT device.

For example, the device control transaction identifier, namely, an AIoT NAS transaction ID, is used for marking such an AIoT NAS command message, such an AIoT NAS command process, such a core network control request message, or such a core network control request process.

In this embodiment of this application, the first network element may send information such as the device control information, the device control type, or the device identifier information of the Internet of Things device to trigger obtaining the identifier information of the Internet of Things device or trigger performing the first control on the Internet of Things device, thereby accurately controlling the Internet of Things device that needs to be controlled.

In this embodiment of this application, the device control information is encapsulated through a specific communication protocol between the Internet of Things device and the first network element.

In this embodiment of this application, the device control information is information encrypted by using a preconfigured key.

In this embodiment of this application, the device control information includes at least one of the following:
a control type corresponding to the device control information,
a security parameter corresponding to the device control information,
a read parameter corresponding to the device control information,
a write parameter corresponding to the device control information,
write parameter content corresponding to the device control information,
a control cycle of the device control information, and
a control frequency of the device control information.

In this embodiment of this application, the first network element sends the first information, to trigger obtaining the identifier information of the Internet of Things device or trigger performing the first control on the Internet of Things device, so that the Internet of Things server controls the Internet of Things device by using the first network element in the wireless network. In this way, the first network element may assist in controlling the Internet of Things device, thereby improving coverage of a network architecture including the Internet of Things device, and supporting large-scale cellular networking deployment, massive Internet of Things devices, and seamless coverage.

In this embodiment of this application, step S202 may be implemented by using the following step S202a.

Step S202a: The first network element sends the first information to a read/write device.

A function of the first information includes at least one of the following: triggering the read/write device to obtain the identifier information of the Internet of Things device, and triggering the read/write device to perform the first control on the Internet of Things device.

In this embodiment of this application, the first network element may determine the read/write device according to parameter information in the received first control request message and send the first information to the read/write device. In some embodiments, the AMF may further determine the read/write device according to reader information corresponding to the Internet of Things device.

In this embodiment of this application, the read/write device may be a terminal device (namely, a UE) or a base station (namely, a RAN).

In this embodiment of this application, the read/write device is the terminal device, and the first information is encapsulated through a NAS protocol; or

the read/write device is the base station, and the first information is encapsulated through an NGAP protocol.

In this embodiment of this application, step S202a may be implemented by using the following step S202a1 or step S202a2.

Step S202a1: When the read/write device is a terminal device, the first network element sends the first information to the read/write device through a NAS connection of the terminal device, or the first network element sends the first information through a NAS connection of the Internet of Things device.

The NAS connection of the Internet of Things device is established by the terminal device for the Internet of Things device.

Step S202a2: When the read/write device is a base station, the first network element sends the first information to the read/write device through a NAS connection of the Internet of Things device.

The NAS connection of the Internet of Things device is established by the base station for the Internet of Things device.

For example, in a case that the read/write device is the terminal device, the first information is sent through the NAS connection of the terminal device or the NAS connection of the Internet of Things device.

For example, in a case that the read/write device is the base station, the first information is sent through the NAS connection of the Internet of Things device.

For example, the first information may include at least the control type (that is, the AIoT command Type) corresponding to the device control information and the device control information (that is, the AIoT NAS command).

In this way, in a case that the read/write device is the base station or the terminal device, the first network element may send the first information through the NAS connection between the Internet of Things device and the first network element, or in a case that the read/write device is the terminal device, the first network element may send the first information through the NAS connection of the terminal device, thereby flexibly and efficiently sending the first information.

In some examples, the device control information is an AIoT control command encapsulated through a specific communication protocol for communication between the AIoT device and the AMF.

Using an example in which the first network element is the AMF and the first information includes: the AIoT command Type, the AIoT device identifier information, the AIoT NAS command, and the AIoT command cycle/frequency, a message format of the first information sent by the AMF to the read/write device when the read/write device is a RAN or a UE is separately described exemplarily.

Example 1: The read/write device is a RAN. AMF->reader RAN: an NGAP message (having an NGAP header).

| | | | | |
|---|---|---|---|---|
| NGAP | AIOT | AIOT device | AIOT | AIOT |
| header | command | identifier | NAS | command |
| | type | information | command | cycle/ |
| | | | | frequency |

Example 2: The read/write device is a UE. AMF->reader UE: an NGAP message (having an NGAP header).

| | | | | | |
|---|---|---|---|---|---|
| NAS | AIOT | AIOT device | AIOT | AIOT NAS | AloT |
| header | command | identifier | NAS | command | command |
| | type | information | command | | cycle/ |
| | | | | | frequency |

It needs to be noted that when the AIoT command type is inventory, the message may not include an AIoT NAS command/AIoT command content, or an AIoT NAS command parameter/AIoT command content is set to null.

In some other examples, there is no independent protocol stack between the AIoT device and the AMF. That is, the device control information is an AIoT control command that is not encapsulated through the specific communication protocol for communication between the AIoT device and the AMF.

Using an example in which the first network element is the AMF and the first information includes: the AIoT device identifier information, the AIoT transaction ID, the AIoT command, and the AIoT command cycle/frequency, a message format of the first information sent by the AMF to the read/write device when the read/write device is a RAN or a UE is separately described exemplarily.

Example 3: The read/write device is a RAN. AMF->reader RAN: an NGAP message (having an NGAP header).

| | | | | |
|---|---|---|---|---|
| NGAP | AloT device | AIOT | AIOT | AloT |
| header | identifier | transaction | command | command |
| | information | ID | | cycle/ |
| | | | | frequency |

Example 4: The read/write device is a UE. AMF->reader UE: a NAS message (having a NAS header) of the UE.

| | | | | |
|---|---|---|---|---|
| NAS | AIOT device | AIOT | AIOT | AIOT |
| header | identifier | transaction | command | command |
| | information | ID | | cycle/ |
| | | | | frequency |

In this embodiment of this application, the first network element may send the first information to the read/write device, to trigger the read/write device to obtain the identifier information of the Internet of Things device, or trigger the read/write device to perform the first control on the Internet of Things device, so that the read/write device can accurately obtain the identifier information of the Internet of Things device or accurately control the Internet of Things device.

In this embodiment of this application, step S202 may be implemented by using the following step S202b.

Step S202b: The first network element sends the first information to the Internet of Things device.

The first information includes first device control information, where the first device control information is encapsulated based on a specific communication protocol for communication between the Internet of Things device and the first network element, and the first device control information is used for performing the first control on the Internet of Things device.

For example, the first information may include at least the device control information (AIoT NAS command). Further, the first information may further include at least one of the AIoT command cycle/frequency, the AIoT device identifier information, and the AIoT NAS transaction ID.

In some examples, the device control information is an AIoT control command encapsulated through a specific communication protocol between the AIoT device and the AMF.

In this embodiment of this application, step S202b may be implemented by using the following step S202bl.

In this embodiment of this application, the first network element may send the first information to the Internet of Things device, to perform first control on the Internet of Things device, thereby improving communication performance of the Internet of Things device.

Step S202bl: The first network element instructs the read/write device to send the first device control information to the Internet of Things device.

In this embodiment of this application, the first network element may send the first device control information to the read/write device, and forward the first device control information to the Internet of Things device by using the read/write device.

In this embodiment of this application, the specific communication protocol is a specific protocol dedicated to communication between the first network element and the Internet of Things device, and both the first network element and the Internet of Things device support the specific communication protocol. For example, using an example in which the first network element is an AMF, and the Internet of Things device is an AIoT device, the specific communication protocol is a protocol dedicated to communication between the AMF and the AIoT device.

It needs to be noted that for explanations and descriptions of the first device control information, refer to the foregoing descriptions. Details are not described herein again.

It needs to be noted that the first device control information is encapsulated based on the specific communication protocol for communication between the Internet of Things device and the first network element, and the read/write device cannot parse the first device control information. Therefore, the read/write device forwards the first device control information to the Internet of Things device.

Using an example in which the first network element is an AMF and the first information includes: the AIoT device identifier information, the AIoT NAS command, and the AIoT command cycle/frequency, a message format of the first information sent by the AMF to the read/write device when the read/write device is a RAN or a UE is separately described exemplarily.

Example 5: The read/write device is a RAN. AMF->reader RAN: an NGAP message (having an NGAP header).

| | | | | |
|---|---|---|---|---|
| NGAP | AIOT | AIOT | AIOT | AIOT NAS |
| header | NAS | command | device identifier | transaction |
| | command | cycle/frequency | information | ID |

Example 6: The read/write device is a UE. AMF->reader UE: a NAS message (having a NAS header).

| | | | | |
|---|---|---|---|---|
| NAS | AIOT | AloT | AIOT | AIOT NAS |
| header | NAS | command | device identifier | transaction |
| | command | cycle/frequency | information | ID |

In this embodiment of this application, the first network element may send the first information to the Internet of Things device by using the read/write device, to perform first control on the Internet of Things device, thereby improving communication performance of the Internet of Things device.

In this embodiment of this application, before step S202b, the method for controlling an Internet of Things device provided in this embodiment of this application further includes the following step A1 and step A2.

Step A1: The first network element sends second device control information to the Internet of Things device.

The second device control information is used for obtaining the identifier information of the Internet of Things device.

In this embodiment of this application, the first network element may send the second device control information to the Internet of Things device by using the read/write device.

Step A2: The first network element receives the identifier information from the Internet of Things device.

In this embodiment of this application, the first network element may receive the identifier information from the Internet of Things device by using the read/write device.

In this embodiment of this application, the second device control information may be an inventory request message. The inventory request message is used for obtaining the device identifier of the Internet of Things device. For example, the second device control message may be represented as an AIoT NAS command or an AIoT NAS Inventory Request.

For example, using an example in which the first network element is an AMF, the AMF may determine the read/write device and send the NAS inventory request message to the read/write device. For example, the AMF may determine the read/write device according to the parameter information in the first control request message, or determine the read/write device according to reader information corresponding to the AIoT device.

For example, the AMF may further send at least one of the following to the read/write device: the AIoT command cycle/frequency, the AIoT device identifier information, and the AIoT NAS transaction ID.

The AIoT command type indicates inventory. The AIoT NAS transaction ID is used for marking such a NAS inventory request or such a NAS inventory request process. The AIoT NAS command may be replaced with the AIoT NAS Inventory Request.

For example, the read/write device may be a RAN or a UE.

Using an example in which the first network element is an AMF and the second device control information includes the AIoT NAS command, a message format of information including the AIoT NAS command sent by the AMF to the read/write device when the read/write device is a RAN or a UE is separately described exemplarily.

Example 7: The read/write device is a RAN. AMF->reader RAN: an NGAP message (having an NGAP header).

| | | | | |
|---|---|---|---|---|
| NGAP | AIOT NAS | AIOT | AIOT | AIOT NAS |
| header | Inventory | command | device identifier | transaction |
| | Request | cycle/frequency | information | ID |

Example 8: The read/write device is a UE. AMF->reader UE: a NAS message (having a NAS header).

| | | | | |
|---|---|---|---|---|
| NAS | AIOT NAS | AIOT | AIOT | AIOT NAS |
| header | Inventory | command | device identifier | transaction |
| | Request | cycle/frequency | information | ID |

In this embodiment of this application, when needing to communicate with the Internet of Things device, the first network element may send an inventory request to the Internet of Things device, to obtain the identifier information of the Internet of Things device, thereby improving communication efficiency.

In this embodiment of this application, after step S202, the method for controlling an Internet of Things device provided in this embodiment of this application further includes the following step S203.

Step S203: The first network element receives a first device control response.

The first device control response includes at least one of the following:
a result of processing the device control information by the Internet of Things device,
a cause value corresponding to the device control information,
a write result corresponding to the device control information,
a sending cycle of the device control information,
a sending frequency of the device control information, and
the identifier information of the Internet of Things device.

In this embodiment of this application, the first network element may receive the first device control response from the Internet of Things device.

In this embodiment of this application, the Internet of Things device may first send the first device control response to the read/write device, and the read/write device sends the first device control response to the AMF.

It should be noted that, the read/write device may forward the first device control response from the Internet of Things device to the AMF, or may convert the first device control response from the Internet of Things device into a message between the read/write device and the AMF, and send the message to the AMF.

In this embodiment of this application, the first device control response is encapsulated through a specific communication protocol between the first network element and the read/write device; or the first device control response is encapsulated through the specific communication protocol between the Internet of Things device and the first network element.

In this embodiment of this application, the specific communication protocol between the first network element and the read/write device is used for communication between the first network element and the read/write device.

For example, the first device control response (an AIoT command response) may be an AIoT device control response encapsulated by a protocol stack (for example, the NAS) between the AIoT device and the AMF, and includes at least one of a device control response type (an AIoT command response type) and device control response content.

For example, the device control response content may include at least one of the following: a result of processing the AIoT NAS command by the AIoT device, a cause value, a read result, or a write result, the AIoT command cycle/frequency, the AIoT device identifier information, the AIoT device service identifier, and the AIoT device group service identifier. In some embodiments, some or all of the parameters may be encrypted by using a preconfigured key or a key negotiated with the core network.

In this embodiment of this application, all or some of parameters in the first device control response may be encrypted by using a preconfigured key or a key negotiated with the core network.

In this embodiment of this application, after receiving the first device control response from the Internet of Things device, the first network element sends the AIoT control response to the Internet of Things server (that is, the AIoT App).

For example, the AIoT control response includes at least one of the following parameters: area information, the AIoT device service identifier, the AIoT device group service identifier, and the response type.

For example, using an example in which the first network element is an AMF, the AMF may send the control response message to the AIoT App in one of the following manners:
sending the control request message to the AIoT App by using a Network Exposure Function (NEF);
sending the control request message to the AIoT App by using the NEF and UDM; and
sending the control request message to the AIoT App by using the NEF and an AIoT NF.

In this embodiment of this application, the first network element may receive information from the Internet of Things device, such as a processing result, a cause value, a read result, or a write result, and send the information to the Internet of Things server, so that the Internet of Things server can accurately and efficiently obtain the information from the Internet of Things device, thereby improving communication efficiency.

FIG. 3 is another flowchart of a method for controlling an Internet of Things device according to an embodiment of this application. As shown in FIG. 3, the method for controlling an Internet of Things device may include the following step S301 and step S302.

S301: A read/write device receives first information.

In this embodiment of this application, the first information includes at least one of the following:
device control information,
a device control type,
device identifier information of the Internet of Things device,
a sending cycle of the device control information,
a sending frequency of the device control information,
a device control transaction identifier, where the device control transaction identifier is used for marking a device control process corresponding to the first information,
a security parameter corresponding to device control,
a read parameter,
a write parameter, and
write parameter content.

In this embodiment of this application, step S301 may be replaced with the following step S301a.

Step S301a: The read/write device receives the first information from a first network element.

It needs to be noted that for descriptions of the first network element and the first information, refer to the foregoing descriptions. Details are not described herein again.

In this embodiment of this application, the read/write device includes a terminal device, and the first information is encapsulated through a NAS protocol; or

the read/write device includes a base station, and the first information is encapsulated through an NGAP protocol.

S302: The read/write device performs a first operation according to the first information, where the first operation includes at least one of the following:
obtaining the identifier information of the Internet of Things device; and
performing first control on the Internet of Things device.

It needs to be noted that for explanations and descriptions of the first control, refer to the foregoing descriptions. Details are not described herein again.

According to the method for controlling an Internet of Things device provided in this embodiment of this application, the read/write device may receive the first information, and obtain the identifier information of the Internet of Things device based on the first information, or perform the first control on the Internet of Things device, thereby improving communication performance of the Internet of Things device.

In this embodiment of this application, step S301a may include the following step S301al and step S301a2.

Step S301al: When the read/write device is a terminal device, the read/write device receives the first information from the first network element through a NAS connection of the terminal device, or the read/write device receives the first information through a NAS connection of the Internet of Things device.

The NAS connection of the Internet of Things device is established by the terminal device for the Internet of Things device.

Step S301a2: When the read/write device is a base station, the read/write device receives the first information from the first network element through a NAS connection of the Internet of Things device.

The NAS connection of the Internet of Things device is established by the base station for the Internet of Things device.

In this embodiment of this application, a process of the performing first control on the Internet of Things device may include the following step S302a.

Step S302a: The read/write device sends first device control information to the Internet of Things device.

The first device control information is used for at least one of the following:
obtaining the identifier information of the Internet of Things device; and
performing the first control on the Internet of Things device.

It needs to be noted that for explanations and descriptions of the first device control information, refer to the foregoing descriptions. Details are not described herein again.

For example, the read/write device sends an AIoT NAS command transmission message to the AIoT device, including an AIoT NAS command (namely, the first device control information). In some embodiments, the AIoT NAS command transmission message may further include at least one of AIoT device identifier information and an AIoT NAS transaction ID.

For example, a message format of a reader->an AIoT device is as follows:

| | | | |
|---|---|---|---|
| AIOT | AIOT | AIOT | AIOT NAS |
| AN | NAS | device identifier | transaction |
| header | command | information | ID |

In this embodiment of this application, before sending the first device control information to the Internet of Things device, the read/write device may further send an inventory request message to the Internet of Things device.

In some embodiments, the inventory request message may include an AIoT inventory command. Further, the inventory request message may further include at least one of an inventory indication parameter, the AIoT device identifier information, and the AIoT NAS transaction ID.

It needs to be noted that the AIoT device identifier information may be included in the AIoT inventory command, or may not be carried in the AIoT inventory command, but is used as a parameter parallel to the AIoT inventory command.

For example, the message format of the reader->the AIoT device is as follows:

| | | | |
|---|---|---|---|
| AIOT | AIOT | AloT | AIOT NAS |
| AN | Inventory | device identifier | transaction |
| header | command | information | ID |

In this embodiment of this application, the message format of information sent by the read/write device to the Internet of Things device and the message format of inventory request message sent by the read/write device to the Internet of Things device in step S302a may be unified as follows:

| | | | | |
|---|---|---|---|---|
| AIOT | AIOT | AIOT | AloT | AIOT NAS |
| AN | Inventory | NAS | device identifier | transaction |
| header | command | command | information | ID |

When that the read/write device sends the inventory request message to the AIoT device is performed, an AIoT NAS command part in a message format may be omitted or set to null.

In this embodiment of this application, after the read/write device sends the inventory request message to the Internet of Things device, the read/write device may receive an inventory response message from the AIoT device, including the AIoT device identifier information.

For example, a message format of the AIoT device->the reader is as follows:

| | | |
|---|---|---|
| AIOT | AIOT | AIOT NAS |
| AN | Inventory | transaction |
| header | response | ID |

or

| | | |
|---|---|---|
| AIoT AN | AIoT device identifier | AIoT NAS |
| header | information | transaction ID |

In this embodiment of this application, the first device control information is encapsulated through a specific communication protocol between the Internet of Things device and the read/write device.

In some embodiments, the method for controlling an Internet of Things device provided in this embodiment of this application may further include the following step S303 and step S304.

Step S303: The read/write device receives a first device control response from the Internet of Things device.

Step S304: The read/write device sends the first device control response to the first network element.

The first device control response includes at least one of the following:
a result of processing the device control information by the Internet of Things device,
a cause value corresponding to the first device control information,
a write result corresponding to the first device control information,
a sending cycle of the first device control information,
a sending frequency of the first device control information, and
the identifier information of the Internet of Things device.

It should be noted that, the read/write device may forward the first device control response from the Internet of Things device to the first network element, or may convert the first device control response from the Internet of Things device into a message between the read/write device and the first network element, and send the message to the first network element.

In this embodiment of this application, the first device control response is encapsulated through the specific communication protocol between the Internet of Things device and the read/write device; or the first device control response is encapsulated through a specific communication protocol between the Internet of Things device and the first network element.

In some embodiments, the read/write device may further send at least one of the following to the first network element: an AIoT command cycle/frequency, and the AIoT device identifier information.

The following describes a message format between the read/write device and the AMF in a case that the device control response is encapsulated through the specific communication protocol between the Internet of Things device and the first network element.

For example, using an example in which the read/write device is a RAN, and the first network element is an AMF, a message format of the reader->the AMF is as follows:

### RAN Reader:

| | | | | |
|---|---|---|---|---|
| NGAP | AIOT | AIOT | AIOT NAS | AIOT NAS |
| header | command | device identifier | command | transaction |
| | response type | information | response | ID |

For example, using an example in which the read/write device is a UE, and the first network element is an AMF, the message format of the reader->the AMF is as follows:

### UE Reader:

| | | | | |
|---|---|---|---|---|
| NAS | AIOT | AIOT | AIOT NAS | AIOT NAS |
| header | command | device identifier | command | transaction |
| | response type | information | response | ID |

It should be noted that, the AMF may determine, according to the AIoT NAS transaction ID parameter, which AIoT NAS command is associated with the AIoT NAS command response.

The following describes a message format between the read/write device and the AMF in a case that the device control response is not encapsulated through the specific communication protocol between the Internet of Things device and the read/write device.

For example, the message format of the reader->the AMF is as follows:

### RAN Reader:

| | | | |
|---|---|---|---|
| NGAP | AIOT | AIOT | AIOT |
| header | device | transaction | command |
| | ID | ID | response |

### UE Reader:

| | | | |
|---|---|---|---|
| NAS | AIoT | AIoT | AIoT command |
| header | device ID | transaction ID | response |

It needs to be noted that a parameter in the AIoT command response may be determined according to a corresponding parameter in an AIoT reader command, which may be the same or may be different.

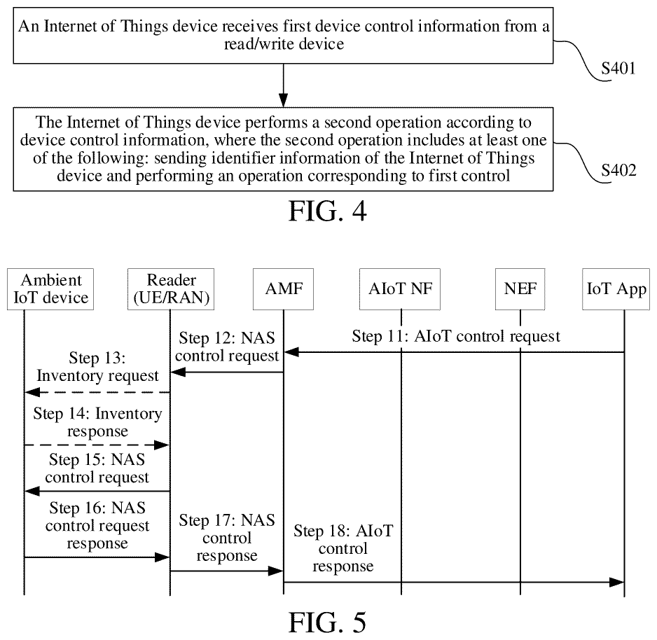

FIG. 4 is another flowchart of a method for controlling an Internet of Things device according to an embodiment of this application. As shown in FIG. 4, the method for controlling an Internet of Things device may include the following step S401 and step S402.

S401: An Internet of Things device receives first device control information from a read/write device.

In this embodiment of this application, the first device control information may be information sent by a first network element to the Internet of Things device by using the read/write device.

In this embodiment of this application, the first device control information includes first identifier information, and identifier information of the Internet of Things device matches the first identifier information.

It needs to be noted that for explanations and descriptions of the first device control information, refer to the foregoing descriptions. Details are not described herein again.

S402: The Internet of Things device performs a second operation according to the first device control information.

The performing a second operation includes at least one of the following:
sending identifier information of the Internet of Things device; and
performing an operation corresponding to first control.

It needs to be noted that for explanations and descriptions of the first control, refer to the foregoing descriptions. Details are not described herein again.

According to the method for controlling an Internet of Things device provided in this embodiment of this application, the Internet of Things device may receive the device control information from the read/write device, and perform the second operation based on the device control information. The second operation may include at least one of the following: sending the identifier information of the Internet of Things device; and performing the operation corresponding to the first control, thereby improving communication performance of the Internet of Things device.

In this embodiment of this application, after step S402, the method for controlling an Internet of Things device provided in this embodiment of this application further includes the following step S403.

Step S403: The Internet of Things device sends a first device control response.

The first device control response includes at least one of the following:
a result of processing the first device control information by the Internet of Things device,
a cause value corresponding to the first device control information,
a write result corresponding to the first device control information,
a sending cycle of the first device control information,
a sending frequency of the first device control information, and
the identifier information of the Internet of Things device.

In this embodiment of this application, the Internet of Things device may send the first device control response (namely, an AIoT NAS command response) to the read/write device.

In this embodiment of this application, the first device control response is encapsulated through a specific communication protocol between the Internet of Things device and the read/write device; or the first device control response is encapsulated through a specific communication protocol between the Internet of Things device and the first network element.

In this embodiment of this application, the first device control response is encrypted by using information encrypted by using a preconfigured key.

In some embodiments, the Internet of Things device may further send at least one of AIoT device identifier information and an AIoT NAS transaction ID to the read/write device.

For example, the message format of the AIoT device->the reader is as follows:

| | | | |
|---|---|---|---|
| AIoT AN | AIoT NAS | AIoT device identifier | AIoT NAS |
| header | command response | information | transaction ID |

In this embodiment of this application, before the Internet of Things device receives the first device control information from the read/write device in step S401, the Internet of Things device may further receive an inventory request message sent by the read/write device, and send an inventory response message to the read/write device.

It needs to be noted that for descriptions of the message format between the Internet of Things device and the read/write device, refer to the foregoing descriptions. Details are not described herein again.

The method for controlling an Internet of Things device is described below with reference to embodiments by using an example in which the Internet of Things device is an AIoT device, the read/write device is a reader, and the first network element is an AMF.

### Embodiment 1

There is an independent protocol stack (a NAS protocol stack is used as an example below) between the AIoT device and the AMF, to encapsulate command signaling to the AIoT device and a corresponding response message of the AIoT device.

The AMF receives a request of an App, and sends an encapsulated control command to the AIoT device. The AMF sends the encapsulated control command to the reader. The AMF indicates a type of the control command to the reader.

The reader receives a message from the AMF, first executes an inventory command, and then sends the encapsulated control command from a network to a corresponding device. If the encapsulated control command is only inventory, the network no longer encapsulates one inventory command, and directly instructs the reader to perform an inventory procedure.

For example, as shown in FIG. 5, the method for controlling an Internet of Things device provided in this embodiment of this application may further include the following step 11 to step 18.

Step 11: An AIoT App sends an AIoT control request message to the AMF.

For example, the AIoT control request message is the first control request message in the foregoing embodiment.

It needs to be noted that for explanations and descriptions of the first control request message, refer to the foregoing descriptions. Details are not described herein again.

Step 12: The AMF sends a NAS control request message to the reader.

For example, the NAS control request message is the first information in the foregoing embodiment.

It needs to be noted that for explanations and descriptions of the first information, refer to the foregoing descriptions. Details are not described herein again.

In some embodiments, after step 12, the method may further include the following step 13 and step 14.

Step 13: The reader sends an inventory request message to the AIoT device.

For example, the inventory request message may be an AIoT inventory command. An Inventory indication parameter may be included. In some embodiments, AIoT device identifier information may be further included. The AIoT device identifier information may not be placed in the AIoT inventory command, but is used as an independent parameter.

In some embodiments, the reader further sends an AIoT NAS transaction ID to the AIoT.

For example, the message format of the reader->the AIoT device is as follows:

| | | | |
|---|---|---|---|
| AIoT AN | AIoT Inventory | AIoT device identifier | AIoT NAS |
| header | command | information | transaction ID |

The AIoT inventory command is the inventory request message.

Step 14: The reader receives an inventory response message from the AIoT device.

For example, the inventory response message includes the AIoT device identifier information.

In some embodiments, the AIoT device further sends the AIoT NAS transaction ID to the reader.

For example, the message format of the AIoT device->the reader is as follows:

| | | |
|---|---|---|
| AIoT AN | AIoT Inventory | AIoT NAS |
| header | response | transaction ID |
| or | | |
| AIoT AN | AIoT device identifier | AIoT NAS |
| header | information | transaction ID |

Step 15: The reader sends an AIoT NAS command to the AIoT device.

In some embodiments, the reader sends the AIoT NAS command only to an AIoT device matching the AIoT device service identifier in the control request message in step 12.

For example, the reader sends an AIoT NAS command transmission message to the AIoT device, including the AIoT NAS command. In some embodiments, at least one of the AIoT device identifier information and the AIoT NAS transaction ID may be further included.

For example, the message format of the reader->the AIoT device is as follows:

| | | | |
|---|---|---|---|
| AIoT AN | AIoT NAS | AIoT device identifier | AIoT NAS |
| header | command | information | transaction ID |

It should be noted that message formats of the reader->the AIoT device in step 13 and step 15 may be unified as follows:

| | | | | |
|---|---|---|---|---|
| AIoT AN | AIoT | AIoT | AIoT device | AIoT NAS |
| header | Inventory | NAS | identifier | transaction |
| | command | command | information | ID |

When step 13 of the reader sending the inventory message to the AIoT device, an AIoT NAS command part may be omitted or set to null.

Step 16: The AIoT device sends an AIoT NAS command response to the reader.

For example, the NAS command response is an AIoT control response encapsulated by a protocol stack (for example, the NAS) between the AIoT device and the AMF, and includes at least one of an AIoT command response type and AIoT command response content.

For example, the AIoT command response content includes at least one of the following: a result of processing the AIoT NAS command by the AIoT device, a cause value, a read result, or a write result, an AIoT command cycle/frequency, AIoT device identifier information, an AIoT device service identifier, and an AIoT device group service identifier. In some embodiments, some or all of the parameters may be encrypted by using a preconfigured key or a key negotiated with the core network.

In some embodiments, the AIoT device may further send at least one of the AIoT device identifier information and the AIoT NAS transaction ID to the reader.

For example, the message format of the AIoT device->the reader is as follows:

| | | | |
|---|---|---|---|
| AIoT AN | AIoT NAS command | AIoT device | AIoT NAS |
| header | response | identifier information | transaction ID |

It should be noted that, the messages in step 14 and step 16 may be combined into a unified message format:

| | | | | |
|---|---|---|---|---|
| AIoT AN | AIoT device | AIoT NAS | AIoT | AIoT NAS |
| header | identifier | command | Inventory | transaction |
| | information | response | response | ID |

When the AIoT device sends the inventory response to the reader, the AIoT NAS command response part may be omitted or set to null.

It should be noted that, the reader may determine, according to the AIoT NAS transaction ID parameter, which AIoT NAS command is associated with the AIoT NAS command response. Further, the AIoT NAS command response may be sent to the AMF sending the AIoT NAS command.

Step 17: The reader sends the AIoT NAS command response to the AMF.

In some embodiments, the reader further sends the AIoT command response type and the AIoT device identifier information to the AMF. The AIoT command response type indicates a type of a responded AIoT command, and corresponding to the AIoT command type, may have a same value as the AIoT command type, or may indicate a response of the AIoT command type.

For example, the message format of the reader->the AMF is as follows:

### RAN Reader:

| | | | | |
|---|---|---|---|---|
| NGAP | AIoT | AIoT device | AIoT NAS | AIoT NAS |
| header | command | identifier | command | transaction |
| | response type | information | response | ID |

### UE Reader:

| | | | | |
|---|---|---|---|---|
| NAS header | AIoT | AIoT device | AIoT NAS | AIoT NAS |
| | command | identifier | command | transaction |
| | response type | information | response | ID |

It should be noted that, the AMF may determine, according to the AIoT NAS transaction ID parameter, which AIoT NAS command is associated with the AIoT NAS command response.

Step 18: The AMF sends a control AIoT response message to the AIoT App.

The AIoT response message includes at least one of the following parameters: an area, an AIoT device service identifier, an AIoT device group service identifier, and a response type.

For example, the AMF may send the control response message to the AIoT App in one of the following manners:
(A) sending a control request message to the AIoT App by using an NEF;
(B) sending the control request message to the AIoT App by using the NEF and UDM; and
(C) sending the control request message to the AIoT App by using the NEF and an AIoT NF.

In a possible implementation, step 13 and step 14 are omitted. After step 12, the reader sends the AIoT NAS command to the AIoT device. In this case, the reader may send the AIoT NAS command by broadcasting or in a group sending manner. An AIoT device receiving the AIoT NAS command may determine, according to the AIoT device identifier in the message, whether the AIoT device needs to process the message. For example, if the AIoT device identifier in the message matches the identifier of the AIoT device, the AIoT device performs step 16.

### Embodiment 2

There is an independent protocol stack between the AIoT device and the AMF, to encapsulate command signaling to the AIoT device and a corresponding response message of the AIoT device.

The AMF receives a request of an App, and sends an encapsulated control command to the AIoT device. The AMF sends the encapsulated control command to the reader. An inventory command is also encapsulated and executed by a core network. A message sent by the reader to a device is a uniform command+Tag ID+Tag group ID. After receiving the message of the reader, the device first checks whether the Tag ID and the Tag group ID point to the device (or are default and represent all devices), if the Tag ID and the Tag group ID point to the device, the device continues to parse the command, otherwise the device discards the command and does not respond. The device needs to parse a command part in the message to learn a type of operation.

In some possible implementations, for various operations, inventory needs to be first executed. In this case, a first encapsulation command is inventory, and after a response by the device to the inventory returns to the AMF, the AMF sends a subsequent command again to the device.

During a procedure, it is considered that the AMF and the device maintain such a “transaction connection”. Such an interaction path is relatively long, the inventor actually has four messages in the RFID, and it is convenient to interact between the reader and a Tag.

In some other possible implementations, for another operation, inventory does not need to be first executed. In this case, the first encapsulation command is a control request. The request message is sent out in a group, and the AIoT device determines whether the message is sent to the AIoT device, and responds only if the message is sent to the AIoT device. A response carries an identifier of the AIoT device.

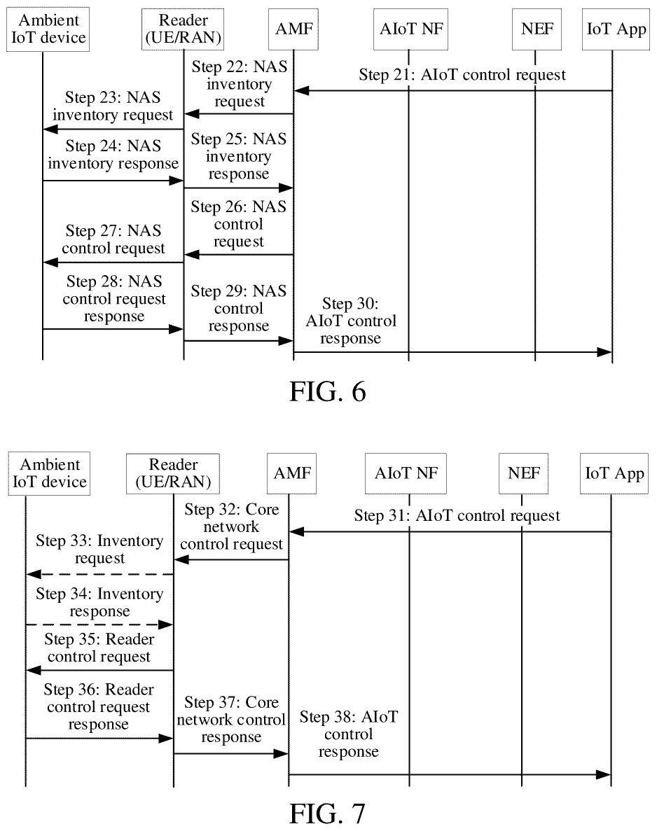

For example, as shown in FIG. 6, the method for controlling an Internet of Things device provided in this embodiment of this application may further include the following step 21 to step 30.

Step 21: An AIoT App sends an AIoT control request message to the AMF.

Step 22: The AMF sends a NAS inventory request message to the reader.

For example, the AMF may determine the reader according to the parameter information in the AIoT control request in step 21, and send the NAS inventory request message to the reader. For example, the NAS inventory request message may be represented by an AIoT NAS command. In some embodiments, the AMF further determines the reader according to reader information corresponding to the AIoT device. In some embodiments, the AMF further sends at least one of the following to the reader: an AIoT command cycle/frequency, AIoT device identifier information, and an AIoT NAS transaction ID.

The AIoT NAS transaction ID is used for marking such a NAS inventory request or such a NAS inventory request process.

For example, the AIoT NAS command may be replaced with an AIoT NAS Inventory Request.

The reader may be a RAN or a UE. A format of the message sent by the AMF when the reader is the RAN or the UE is separately described below.

### AMF->Reader RAN: An NGAP Message (Having an NGAP Header).

| | | | | |
|---|---|---|---|---|
| NGAP | AIoT NAS | AIoT command | AIoT device | AIoT NAS |
| header | command | cycle/ | identifier | transaction |
| | | frequency | information | ID |

### AMF->Reader UE: A NAS Message (Having a NAS Header).

| | | | | |
|---|---|---|---|---|
| NAS header | AIoT | AloT | AIoT device | AIoT NAS |
| | NAS | command | identifier | transaction |
| | command | cycle/frequency | information | ID |

Step 23: The reader sends the NAS inventory request message to the AIoT device.

In some embodiments, the reader further sends at least one of the AIoT device identifier information and the AIoT NAS transaction ID to the AIoT device. The AIoT device identifier information indicates an AIoT device that needs to process the AIoT NAS command.

For example, a message of the reader->the AIoT device is encapsulated by using an AIoT AN header:

| | | | |
|---|---|---|---|
| AIoT AN | AIoT NAS | AIoT device | AIoT NAS |
| header | command | identifier information | transaction ID |

For example, the AIoT NAS command may be replaced with an AIoT NAS Inventory Request.

Step 24: The reader receives a NAS inventory response message from the AIoT device.

In some embodiments, the reader further receives the AIoT device identifier information from the AIoT device.

In some embodiments, the AIoT device further sends the AIoT NAS transaction ID to the reader.

For example, the message format of the AIoT device->the reader is as follows:

| | | | |
|---|---|---|---|
| AIoT AN | AIoT NAS | AIoT device | AIoT NAS |
| header | command response | identifier information | transaction ID |

For example, the AIoT NAS command response may be replaced with an AIoT NAS Inventory Response.

In some embodiments, the reader records the AIoT device identifier information of the AIoT device. If a link is established between the reader and the AIoT device, the reader records a correspondence between the AIoT device identifier information and the link.

Step 25: The reader sends the NAS inventory response message to the AMF.

In some embodiments, the reader further sends at least one of the following to the AMF: the AIoT command cycle/frequency, the AIoT device identifier information, and the AIoT NAS transaction ID. The AIoT command cycle/frequency comes from the message in step 22. The AIoT device identifier information comes from the message in step 24.

For example, a message format of the reader->the AMF is as follows:

### Reader RAN->AMF: An NGAP Message (Having an NGAP Header).

| | | | | |
|---|---|---|---|---|
| NGAP | AIoT NAS | AIoT command | AIoT device | AIoT NAS |
| header | command | cycle/ | identifier | transaction |
| | | frequency | information | ID |

### Reader UE->AMF: A NAS Message (Having a NAS Header).

| | | | | |
|---|---|---|---|---|
| NAS | AIoT NAS | AIoT command | AIoT device | AIoT NAS |
| header | command | cycle/frequency | identifier | transaction |
| | | | information | ID |

Step 26: The AMF sends a core network control request message to the reader.

The core network control request message includes at least one of the following parameters: the AIoT device identifier information, the AIoT NAS command, the AIoT command cycle/frequency, and the AIoT NAS transaction ID.

In some embodiments, when the AIoT device identifier information in the step matches the AIoT device identifier information in step 21 or step 22, the AMF sends the core network control request message to the reader.

For example, a message format of the AMF->the reader is as follows:

### AMF->Reader RAN: An NGAP Message (Having an NGAP Header).

| | | | | |
|---|---|---|---|---|
| NGAP | AIoT NAS | AIoT command | AIoT device | AIoT NAS |
| header | command | cycle/frequency | identifier | transaction |
| | | | information | ID |

### AMF->Reader UE: A NAS Message (Having a NAS Header)

| | | | | |
|---|---|---|---|---|
| NAS | AIoT NAS | AIoT command | AIoT device | AIoT NAS |
| header | command | cycle/frequency | identifier | transaction |
| | | | information | ID |

Step 27: The reader sends the AIoT NAS command to the AIoT device.

In some embodiments, the reader sends the AIoT NAS command to the AIoT device whose identifier matches the AIoT device identifier information in step 26.

For example, the message format of the reader->the AIoT device is as follows:

| | | | |
|---|---|---|---|
| AIoT AN | AIoT NAS | AIoT device | AIoT NAS |
| header | command | identifier information | transaction ID |

Step 28: The AIoT device sends the AIoT NAS command response to the reader.

In some embodiments, the AIoT device further sends the AIoT device identifier information to the reader.

For example, the message format of the AIoT device->the reader is as follows:

| | | | |
|---|---|---|---|
| AIoT AN | AIoT NAS | AIoT device | AIoT NAS |
| header | command | identifier | transaction ID |
| | response | information | |

Step 29: The reader sends the AIoT NAS command response to the AMF.

In some embodiments, the reader further sends at least one of the following to the AMF: the AIoT command cycle/frequency and the AIoT device identifier information. The AIoT command cycle/frequency comes from the message in step 2. The AIoT device identifier information comes from the message in step 4.

For example, the message format of the reader->the AMF is as follows:

### Reader RAN->AMF: An NGAP Message (Having an NGAP Header).

| | | | | |
|---|---|---|---|---|
| NGAP | AIoT NAS | AIoT command | AIoT device | AIoT NAS |
| header | command | cycle/frequency | identifier | transaction |
| | | | information | ID |

### Reader UE->AMF: A NAS Message (Having a NAS Header)

| | | | | |
|---|---|---|---|---|
| NAS | AIoT NAS | AIoT command | AIoT device | AIoT NAS |
| header | command | cycle/frequency | identifier | transaction |
| | | | information | ID |

Step 30: The AMF sends a control AIoT response message to the AIoT App.

It needs to be noted that for related explanations and descriptions of this embodiment, refer to the descriptions of Embodiment 1.

### Embodiment 3

There is no independent protocol stack between the AIoT device and the AMF, and there is a protocol stack only between the AIoT device and the reader (the UE or the RAN).

In some possible implementations, the AMF needs to instruct to the reader what control command is executed. In this case, control signaling may be transmitted by reusing a capability exposure channel.

In some other possible implementations, a part of the command of the AIoT device sent for the reader and that is not intended to be visible to the reader may be encrypted.

For example, as shown in FIG. 7, the method for controlling an Internet of Things device provided in this embodiment of this application may further include the following step 31 to step 38.

Step 31: An AIoT App sends an AIoT control request message to the AMF.

Step 32: The AMF sends a core network control request message to the reader.

For example, the core network control request message includes at least one of the following parameters: the AIoT command, the AIoT device identifier information, the AIoT command cycle/frequency, and the AIoT transaction ID.

For example, the reader may be a RAN or a UE. A format of the message sent by the AMF when the reader is the RAN or the UE is separately described below by using an example.

### AMF->Reader RAN: An NGAP Message (Having an NGAP Header).

| | | | | |
|---|---|---|---|---|
| NGAP | AIoT device | AIoT transaction | AIoT | AIoT command |
| header | identifier | ID | command | cycle/frequency |
| | information | | | |

### AMF->Reader UE: A NAS Message (Having a NAS Header) of the UE.

| | | | | |
|---|---|---|---|---|
| NAS | AIoT device | AIoT | AIoT | AIoT command |
| header | identifier | transaction | command | cycle/frequency |
| | information | ID | | |

Step 33: The reader sends an inventory request message to the AIoT device.

For example, the inventory request message may include at least one of the following: the AIoT device identifier information and the AIoT transaction ID.

For example, the reader->the AIoT device:

| | | |
|---|---|---|
| AIoT AN header | AIoT Inventory command | AIoT transaction ID |

The AIoT inventory command is the inventory request message.

In an implementation, when the AIoT command in step 32 indicates inventory control, the reader performs step 33, otherwise does not perform step 33.

In another possible implementation, the reader performs step 33 without considering a type of a control command indicated by the AIoT command in step 32. In other words, after receiving the message in step 32, the reader performs step 33.

Step 34: The reader receives an inventory response message from the AIoT device, including the AIoT device identifier information. For example, the AIoT device->the reader

| | | |
|---|---|---|
| AIoT AN | AIoT device identifier | AIoT |
| header | information | transaction ID |

Step 35: The reader sends an AIoT reader control request message to the AIoT device.

For example, the AIoT reader control request message includes at least one of the following: the AIoT device identifier information and the AIoT reader command.

For example, the message format of the reader->the AIoT device is as follows:

| | | | |
|---|---|---|---|
| AIoT AN | AIoT device | AIoT transaction | AIoT reader |
| header | identifier information | ID | command |

In some embodiments, the reader sends the AIoT reader command only to an AIoT device matching the AIoT device service identifier in the control request message in step 32.

Step 36: The AIoT device sends an AIoT reader control response message to the reader.

For example, the message format of the AIoT device->the reader is as follows:

| | | | |
|---|---|---|---|
| AIoT AN | AIoT | AIoT | AIoT reader |
| header | device ID | transaction ID | command response |

When the AIoT device sends the inventory response to the reader, the AIoT reader command response part may be omitted or set to null.

Step 37: The reader sends an AIoT control response message to the AMF.

For example, the message format of the reader->the AMF is as follows:

### RAN Reader:

| | | | |
|---|---|---|---|
| NGAP | AIoT | AIoT | AIoT command |
| header | device ID | transaction ID | response |

### UE Reader:

| | | | |
|---|---|---|---|
| NAS | AIoT | AIoT | AIoT command |
| header | device ID | transaction ID | response |

It needs to be noted that a parameter in the AIoT command response may be determined according to a corresponding parameter in an AIoT reader command, which may be the same or may be different.

Step 38: The AMF sends an AIoT control response message to the AIoT App.

In another possible implementation, step 33 and step 34 are omitted. After step 32, the reader sends the AIoT reader control request message to the AIoT device. In this case, the reader may send the AIoT reader control request message by broadcasting or in a group sending manner. An AIoT device receiving the AIoT reader control request message may determine, according to the AIoT device identifier in the message, whether the AIoT device needs to process the message. For example, if the AIoT device identifier in the message matches the identifier of the AIoT device, the AIoT device performs step 36.

It needs to be noted that for related explanations and descriptions of this embodiment, refer to the descriptions of the foregoing embodiment.

The method for controlling an Internet of Things device provided in the embodiments of this application may be performed by an apparatus for controlling an Internet of Things device. In this embodiment of this application, the apparatus for controlling an Internet of Things device provided in the embodiments of this application is described by using an example in which the apparatus for controlling an Internet of Things device performs the method for controlling an Internet of Things device.

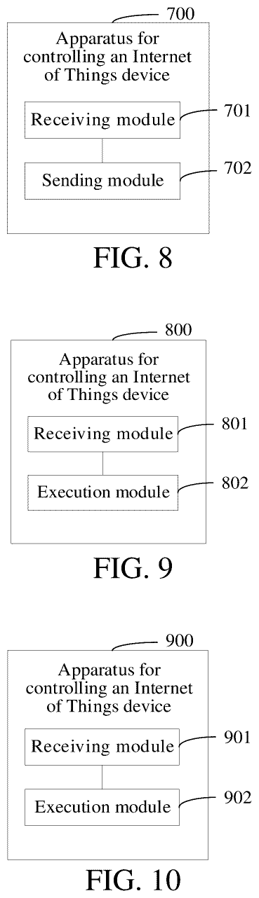

FIG. 8 is a schematic structural diagram of an apparatus for controlling an Internet of Things device according to an embodiment of this application. As shown in FIG. 8, the apparatus 700 for controlling an Internet of Things device may include a receiving module 701 and a sending module 702. The receiving module 701 is configured to receive a first control request message, where the first control request message is used for requesting to perform first control on the Internet of Things device. The sending module 702 is configured to send first information. The first information is used for at least one of the following: triggering obtaining identifier information of the Internet of Things device, and triggering performing the first control on the Internet of Things device.

In this embodiment of this application, the first network element is an access and mobility management function AMF.

In this embodiment of this application, the sending module is configured to send the first information to a read/write device. A function of the first information includes at least one of the following: triggering the read/write device to obtain the identifier information of the Internet of Things device, and triggering the read/write device to perform the first control on the Internet of Things device.

In this embodiment of this application, the sending module is configured to send the first information to the Internet of Things device.

The first information includes first device control information, where the first device control information is encapsulated based on a specific communication protocol for communication between the Internet of Things device and the first network element, and the first device control information is used for performing the first control on the Internet of Things device.

In this embodiment of this application, the sending module is configured to instruct the read/write device to send the first device control information to the Internet of Things device.

In this embodiment of this application, the sending module is further configured to send second device control information to the Internet of Things device, where the second device control information is used for obtaining the identifier information of the Internet of Things device. The receiving module is further configured to receive the identifier information from the Internet of Things device.

In this embodiment of this application, the read/write device includes a terminal device, and the first information is encapsulated through a non-access stratum NAS protocol; or

the read/write device includes a base station, and the first information is encapsulated by using an NG interface application protocol NGAP protocol.

In this embodiment of this application, the sending module is configured to send, in a case that the read/write device is a terminal device, the first information to the read/write device through a NAS connection of the terminal device, or send the first information through a NAS connection of the Internet of Things device, where the NAS connection of the Internet of Things device is established by the terminal device for the Internet of Things device; or the sending module is configured to send, in a case that the read/write device is a base station, the first information to the read/write device through a NAS connection of the Internet of Things device, where the NAS connection of the Internet of Things device is established by the base station for the Internet of Things device.

In this embodiment of this application, the first control request message includes at least one of the following:
area information of an area in which the Internet of Things device is located;
a device service identifier of the Internet of Things device;
a device group service identifier corresponding to the Internet of Things device;
control type information corresponding to the first control;
a cycle of the first control; and
a frequency of the first control.

In this embodiment of this application, the first information includes at least one of the following:
device control information;
a device control type;
device identifier information of the Internet of Things device;
a sending cycle of the device control information;
a sending frequency of the device control information; and
a device control transaction identifier, where the device control transaction identifier is used for marking a device control process corresponding to the first information, where
the device control information is used for at least one of the following:
obtaining the identifier information of the Internet of Things device, and
performing the first control on the Internet of Things device.

In this embodiment of this application, the device control information is encapsulated through a specific communication protocol for communication between the Internet of Things device and the first network element.

In this embodiment of this application, the device control information is information encrypted by using a preconfigured key.

In this embodiment of this application, the device control information includes at least one of the following:
a control type corresponding to the device control information,
a security parameter corresponding to the device control information,
a read parameter corresponding to the device control information,
a write parameter corresponding to the device control information,
write parameter content corresponding to the device control information,
a control cycle of the device control information, and
a control frequency of the device control information.

In this embodiment of this application, the receiving module is further configured to receive a first device control response.

The first device control response includes at least one of the following:
a result of processing the device control information by the Internet of Things device,
a cause value corresponding to the device control information,
a write result corresponding to the device control information,
a sending cycle of the device control information,
a sending frequency of the device control information, and
the identifier information of the Internet of Things device.

In this embodiment of this application, the first device control response is encapsulated through a specific communication protocol between the first network element and the read/write device; or the first device control response is encapsulated through a specific communication protocol between the Internet of Things device and the first network element.

In this embodiment of this application, the first control includes at least one of the following:
inventory, read, write, data transmission, push, activation, deactivation, and data deletion.

According to the apparatus for controlling an Internet of Things device provided in this embodiment of this application, the apparatus for controlling an Internet of Things device sends the first information, to trigger obtaining the identifier information of the Internet of Things device or trigger performing the first control on the Internet of Things device. In this way, the apparatus for controlling an Internet of Things device can control the Internet of Things device, thereby improving communication performance of the Internet of Things device.

FIG. 9 is a schematic structural diagram of another apparatus for controlling an Internet of Things device according to an embodiment of this application. As shown in FIG. 9, the apparatus 800 for controlling an Internet of Things device may include a receiving module 801 and an execution module 802. The receiving module 801 is configured to receive first information. The execution module 802 is configured to perform a first operation according to the first information, where the first operation includes at least one of the following: obtaining identifier information of the Internet of Things device; and performing first control on the Internet of Things device.

In this embodiment of this application, the execution module is configured to send first device control information to the Internet of Things device.

The first device control information is used for at least one of the following:
obtaining the identifier information of the Internet of Things device; and
performing first control on the Internet of Things device.

In this embodiment of this application, the first device control information is encapsulated through a specific communication protocol for communication between the Internet of Things device and a read/write device.

In this embodiment of this application, the receiving module is further configured to receive a first device control response from the Internet of Things device. The apparatus further includes: a sending module. The sending module is configured to send the first device control response to a first network element. The first device control response includes at least one of the following:
a result of processing the device control information by the Internet of Things device,
a cause value corresponding to the first device control information,
a write result corresponding to the first device control information,
a sending cycle of the first device control information,
a sending frequency of the first device control information, and
the identifier information of the Internet of Things device.

In this embodiment of this application, the first device control response is encapsulated through a specific communication protocol between the Internet of Things device and the read/write device; or the first device control response is encapsulated through a specific communication protocol between the Internet of Things device and the first network element.

In this embodiment of this application, the receiving module is configured to receive the first information from the first network element.

In this embodiment of this application, the read/write device includes a terminal device, and the first information is encapsulated through a NAS protocol; or

the read/write device includes a base station, and the first information is encapsulated through an NGAP protocol.

In this embodiment of this application, the receiving module is configured to receive, in a case that the read/write device is a terminal device, the first information from the first network element through a NAS connection of the terminal device, or receive the first information through a NAS connection of the Internet of Things device, where the NAS connection of the Internet of Things device is established by the terminal device for the Internet of Things device; or

the receiving module is configured to receive, in a case that the read/write device is a base station, the first information from the first network element through a NAS connection of the Internet of Things device, where the NAS connection of the Internet of Things device is established by the base station for the Internet of Things device.

In this embodiment of this application, the first information includes at least one of the following:
device control information,
a device control type,
device identifier information of the Internet of Things device,
a sending cycle of the device control information,
a sending frequency of the device control information,
a device control transaction identifier, where the device control transaction identifier is used for marking a device control process corresponding to the first information,
a security parameter corresponding to device control,
a read parameter,
a write parameter, and
write parameter content.

According to the apparatus for controlling an Internet of Things device provided in this embodiment of this application, the apparatus for controlling an Internet of Things device may receive the first information, and obtain the identifier information of the Internet of Things device based on the first information, or perform the first control on the Internet of Things device, thereby improving communication performance of the Internet of Things device.

FIG. 10 is a schematic structural diagram of another apparatus for controlling an Internet of Things device according to an embodiment of this application. As shown in FIG. 10, the apparatus 900 for controlling an Internet of Things device may include a receiving module 901 and an execution module 902. The receiving module 901 is configured to receive first device control information from a read/write device. The execution module 902 is configured to perform a second operation according to the first device control information received by the receiving module 901, where the performing a second operation includes at least one of the following: sending identifier information of an Internet of Things device; and performing an operation corresponding to first control.

In this embodiment of this application, the first device control information includes first identifier information, and identifier information of the Internet of Things device matches the first identifier information.

In this embodiment of this application, after the performing an operation corresponding to the first control, the method further includes:
sending, by the Internet of Things device, a first device control response.

The first device control response includes at least one of the following:
a result of processing the first device control information by the Internet of Things device,
a cause value corresponding to the first device control information,
a write result corresponding to the first device control information,
a sending cycle of the first device control information,
a sending frequency of the first device control information, and
the identifier information of the Internet of Things device.

In this embodiment of this application, the first device control response is encapsulated through a specific communication protocol between the Internet of Things device and the read/write device; or the first device control response is encapsulated through a specific communication protocol between the Internet of Things device and the first network element.

In this embodiment of this application, the first device control response is encrypted by using information encrypted by using a preconfigured key.

According to the apparatus for controlling an Internet of Things device provided in this embodiment of this application, the apparatus for controlling an Internet of Things device may receive the device control information from the read/write device, and perform the second operation based on the device control information. The second operation may include at least one of the following: sending the identifier information of the Internet of Things device; and performing the operation corresponding to the first control, thereby improving communication performance of the Internet of Things device.

The apparatus for controlling an Internet of Things device in the embodiments of this application may be an electronic device, for example, an electronic device having an operating system, or a component in an electronic device, such as an integrated circuit or a chip. The electronic device may be a terminal or another device other than the terminal. For example, the terminal may include, but is not limited to, the foregoing types of the terminal 11, and the another device may be a server, a network attached storage, or the like. This is not specifically limited in the embodiments of this application.

The apparatus for controlling an Internet of Things device provided in the embodiments of this application can implement the processes implemented by the method embodiments in FIG. 1 to FIG. 7, and the same technical effects can be achieved. To avoid repetition, details are not described herein again.

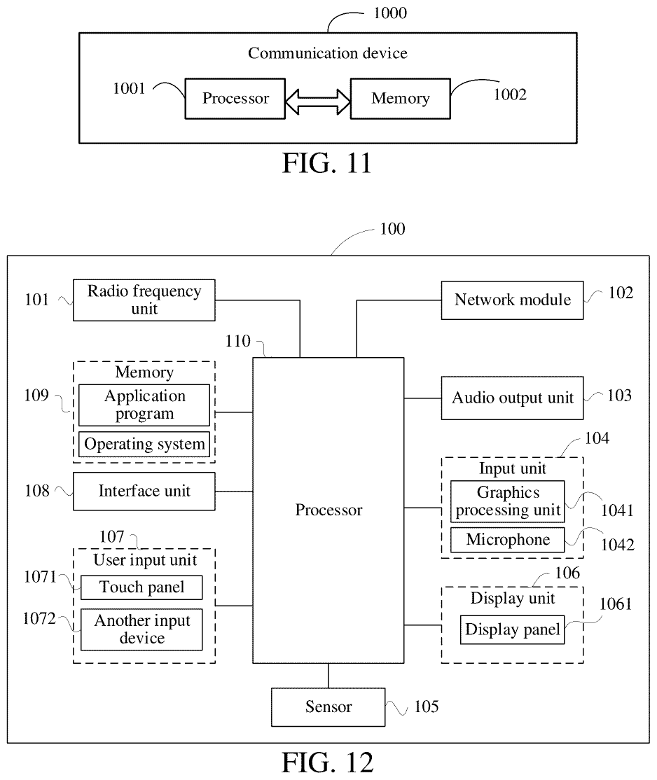

As shown in FIG. 11, an embodiment of this application further provides a communication device 1000, including a processor 1001 and a memory 1002. The memory 1002 stores a program or instructions runnable on the processor 1001. For example, when the communication device 1000 is an Internet of Things device, the program or the instructions, when executed by the processor 1001, implement the steps in the embodiments of the method for controlling an Internet of Things device on the Internet of Things device side, and can achieve the same technical effects. When the terminal device 1000 is a terminal or a base station, the program or the instructions, when executed by the processor 1001, implement the steps in the embodiments of the method for controlling an Internet of Things device on a read/write device side, and can achieve the same technical effects. When the communication device 1000 is a core network device, the program or the instructions, when executed by the processor 1001, implement the steps in the embodiments of the method for controlling an Internet of Things device on a first network element side, and can achieve the same technical effects. To avoid repetition, details are not described herein again.

It needs to be noted that the Internet of Things device may be a terminal, and the read/write device may be a terminal or the network side device.

For example, an embodiment of this application further provides a terminal, including a processor and a communication interface. The communication interface is coupled to the processor, and the processor is configured to run a program or instructions, to implement the steps in the embodiments of the method on the Internet of Things device side or the embodiments of the method on the read/write device side. The terminal embodiment corresponds to the embodiments of the method on the Internet of Things device side or the embodiments of the method on the read/write device side. The implementation processes and the implementations of the foregoing method embodiments are all applicable to the terminal embodiment, and the same technical effects can be achieved.

For example, FIG. 12 is a schematic diagram of a hardware structure of a terminal for implementing an embodiment of this application.

A terminal 100 includes, but is not limited to, at least a part of components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that the terminal 100 may further include a power supply (for example, a battery) that supplies power to each component. The power supply may be logically connected to the processor 110 by using a power management system, thereby managing functions such as charging, discharging, and power consumption by using the power management system. The terminal structure shown in FIG. 12 does not constitute a limitation on the terminal, and the terminal may include components more or fewer than the components shown in the figure, or combine some components, or have different component arrangements. Details are not described herein again.

It should be understood that, in this embodiment of this application, the input unit 104 may include a (Graphics Processing Unit (GPU) 1041 and a microphone 1042, and the graphics processing unit 1041 processes image data of still images or videos obtained by an image capture apparatus (for example, a camera) in a video capture mode or an image capture mode. The display unit 106 may include a display panel 1061, and the display panel 1061 may be configured in a form such as a liquid crystal display or an organic light-emitting diode. For example, the user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include, but is not limited to, a physical keyboard, a functional button (such as a volume control button or a switch button), a trackball, a mouse, or a joystick. Details are not described herein.

In this embodiment of this application, after receiving downlink data from a network side device, the radio frequency unit 101 may transmit the data to the processor 110 for processing. In addition, the radio frequency unit 101 may transmit uplink data to the network side device. Usually, the radio frequency unit 101 includes, but is not limited to, an antenna, an amplifier, a transceiver, a coupler, a low noise amplifier, a duplexer, and the like.

The memory 109 may be configured to store a software program or instructions, and various data. The memory 109 may mainly include a first storage area for storing a program or instructions and a second storage area for storing data. The first storage area may store an operating system, an application program or instructions required by at least one function (for example, a sound playback function or an image playback function), and the like. In addition, the memory 109 may include a volatile memory or a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 109 in this embodiment of this application includes, but is not limited to, these memories and a memory of any other suitable type.

The processor 110 may include one or more processing units. In some embodiments, the processor 110 may integrate an application processor and a modem processor, where the application processor mainly processes operations involving an operating system, a user interface, an application program, and the like, and the modem processor mainly processes a wireless communication signal, for example, a baseband processor. It may be understood that the modem processor may not be integrated into the processor 110.

For example, in a case that the terminal is an Internet of Things device, the radio frequency unit 101 is configured to receive a first control request message, where the first control request message is used for requesting to perform first control on the Internet of Things device. The radio frequency unit 101 is further configured to send first information. The first information is used for at least one of the following: triggering obtaining identifier information of the Internet of Things device, and triggering performing the first control on the Internet of Things device.

For example, in a case that the terminal is a read/write device, the frequency unit 101 is configured to receive first information. The processor 110 is configured to perform a first operation according to the first information. The first operation includes at least one of the following: obtaining identifier information of the Internet of Things device; and performing first control on the Internet of Things device.

It may be understood that the implementation processes of the implementations mentioned in this embodiment may refer to the related descriptions in the method embodiments, and can achieve same or corresponding technical effects. To avoid repetition, details are not described herein again.

An embodiment of this application further provides a network side device, including a processor and a communication interface, where the communication interface is coupled to the processor, and the processor is configured to run a program or instructions, to implement the steps in the method embodiments shown in FIG. 2 or FIG. 3. The network side device embodiment corresponds to the embodiments of the method on the first network element side or corresponds to the embodiments of the method on the read/write device side. The implementation processes and the implementations of the method embodiments are all applicable to the network side device embodiment, and the same technical effects can be achieved.

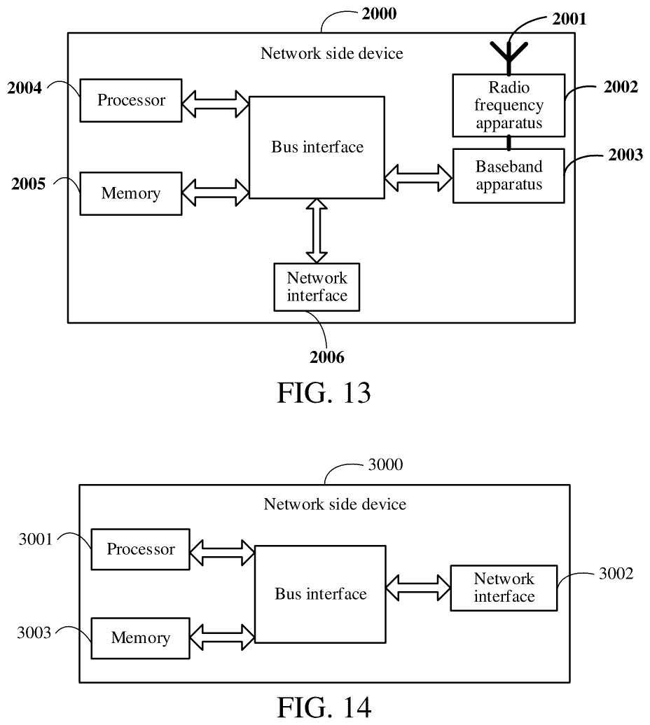

An embodiment of this application further provides a network side device. As shown in FIG. 13, the network side device 2000 includes: an antenna 2001, a radio frequency apparatus 2002, a baseband apparatus 2003, a processor 2004, and a memory 2005. The antenna 2001 is connected to the radio frequency apparatus 2002. In an uplink direction, the radio frequency apparatus 2002 receives information by using the antenna 2001, and sends the received information to the baseband apparatus 2003 for processing. In a downlink direction, the baseband apparatus 2003 processes the information to be sent and sends the information to the radio frequency apparatus 2002. The radio frequency apparatus 2002 processes the received information and sends the information out by using the antenna 2001.

The method performed by the network side device in the foregoing embodiments may be implemented in the baseband apparatus 2003, and the baseband apparatus 2003 includes a baseband processor.

The baseband apparatus 2003 may include, for example, at least one baseband board. A plurality of chips are arranged on the baseband board, as shown in FIG. 13. One of the chips is, for example, a baseband processor, and is connected to the memory 2005 through a bus interface to invoke a program in the memory 2005, to perform the operations of the network device described in the foregoing method embodiments.

The network side device may further include a network interface 2006. The interface is, for example, a Common Public Radio Interface (CPRI).

For example, the network side device 2000 of this embodiment of this application further includes: instructions or a program stored in the memory 2005 and runnable on the processor 2004, and the processor 2004 invokes the instructions or the program in the memory 2005 to perform the method performed by the modules shown in FIG. 8, and achieves the same technical effects. To avoid repetition, details are not described herein again.

For example, an embodiment of this application further provides a network side device. As shown in FIG. 14, the network side device 3000 includes: a processor 3001, a network interface 3002, and a memory 3003. The network interface 3002 is, for example, a CPRI.

For example, the network side device 3000 of this embodiment of this application further includes: instructions or a program stored in the memory 3003 and runnable on the processor 3001, and the processor 3001 invokes the instructions or the program in the memory 3003 to perform the method performed by the modules shown in FIG. 8, and achieves the same technical effects. To avoid repetition, details are not described herein again.

An embodiment of this application further provides an AIoT device, including a processor and a communication interface, where the communication interface is coupled to the processor, and the processor is configured to run a program or instructions, to implement the steps in the method embodiments shown in FIG. 4. The AIoT device embodiment corresponds to the foregoing method embodiment of the Internet of Things device. The implementation processes and implementations of the foregoing method embodiments are all applicable to the network side device embodiment, and the same technical effects can be achieved.

An embodiment of this application further provides a readable storage medium. The readable storage medium stores a program or instructions. The program or the instructions, when executed by a processor, implement the processes of the embodiments of the method for controlling an Internet of Things device, and can achieve the same technical effects. To avoid repetition, details are not described herein again.

The processor is the processor in the terminal in the embodiments described above. The readable storage medium includes a computer-readable storage medium, such as a computer ROM, an RAM, a magnetic disk, an optical disc, or the like. In some examples, the readable storage medium may be a non-transient readable storage medium,

An embodiment of this application further provides a chip. The chip includes a processor and a communication interface. The communication interface is coupled to the processor. The processor is configured to run a program or instructions, to implement the processes of the embodiments of the method for controlling an Internet of Things device, and can achieve the same technical effects. To avoid repetition, details are not described herein again.

It should be understood that the chip mentioned in this embodiment of this application may also be referred to as a system level chip, a system chip, a chip system, or a system on a chip.

An embodiment of this application further provides a computer program/program product. The computer program/program product is stored in a storage medium. The computer program/program product is executed by at least one processor to implement the processes of the embodiments of the method for controlling an Internet of Things device, and can achieve the same technical effects. To avoid repetition, details are not described herein again.

An embodiment of this application further provides a system for controlling an Internet of Things device, including: an Internet of Things device and a network side device. The Internet of Things device may be configured to perform the steps in the method for controlling an Internet of Things device on the Internet of Things device side, and the network side device may be configured to perform the steps in the method for controlling an Internet of Things device on the read/write device side or the steps in the method for controlling an Internet of Things device on the first network element side.

It needs to be noted that the terms “include”, “comprise”, or any other variation thereof herein are intended to cover a non-exclusive inclusion, so that a process, method, article, or apparatus that includes a series of elements not only includes those elements, but also includes other elements that are not explicitly listed or are inherent to such a process, method, article, or apparatus. Without further limitations, an element limited by the statement “including a . . . ” does not preclude the presence of another identical element in a process, method, article, or apparatus that includes the element. In addition, it should be noted that, scopes of the method and the apparatus in the implementations of this application are not limited to performing functions in an order shown or discussed, but may include performing functions in a substantially concurrent manner or in reverse order depending on functionality involved. For example, the methods described may be performed in an order different from the described order, and various steps may be added, omitted, or combined. Moreover, features described with reference to some examples may be combined in another example.

According to the descriptions in the foregoing implementations, a person skilled in the art may clearly learn that the method according to the foregoing embodiments may be implemented by a computer software product with a necessary general-purpose hardware platform, or by hardware. The computer software product is stored in a storage medium (such as a ROM, a RAM, a disk, and an optical disk), including several instructions to enable a terminal or a network side device to perform the methods described in the embodiments of this application.

The embodiments of this application are described with reference to the accompanying drawings. This application is not limited to the specific implementations described above, and the specific implementations described above are merely examples and not limited. A person of ordinary skill in the art may also make various forms of implementations under the inspiration of this application and without departing from the idea of this application and the protection scope of the claims, and such implementations all fall within the protection scope of this application.

What is claimed is:

1. A method for controlling an Internet of Things device, comprising:
receiving, by a first network element, a first control request message, wherein the first control request message is used for requesting to perform first control on the Internet of Things device; and
sending, by the first network element, first information, wherein
the first information is used for at least one of the following:
triggering obtaining identifier information of the Internet of Things device, or
triggering performing the first control on the Internet of Things device.

2. The method according to claim 1, wherein the first network element is an Access and Mobility Management Function (AMF).

3. The method according to claim 1, wherein the sending, by the first network element, first information comprises:
sending, by the first network element, the first information to a read/write device, wherein
a function of the first information comprises at least one of the following: triggering the read/write device to obtain the identifier information of the Internet of Things device, or triggering the read/write device to perform the first control on the Internet of Things device.

4. The method according to claim 1, wherein the sending, by the first network element, first information comprises:
sending, by the first network element, the first information to the Internet of Things device, wherein
the first information comprises first device control information, wherein the first device control information is encapsulated based on a specific communication protocol for communication between the Internet of Things device and the first network element, and the first device control information is used for performing the first control on the Internet of Things device.

5. The method according to claim 4, wherein the sending, by the first network element, the first information to the Internet of Things device comprises:
instructing, by the first network element, the read/write device to send the first device control information to the Internet of Things device.

6. The method according to claim 5, wherein before the first network element sends the first device control information to the Internet of Things device, the method further comprises:
sending, by the first network element, second device control information to the Internet of Things device, wherein the second device control information is used for obtaining identifier information of the Internet of Things device; and
receiving, by the first network element, the identifier information from the Internet of Things device.

7. The method according to claim 3, wherein
the read/write device comprises a terminal device, and the first information is encapsulated through a Non-Access Stratum (NAS) protocol; or
the read/write device comprises a base station, and the first information is encapsulated through a Next Generation Application Protocol (NGAP).

8. The method according to claim 3, wherein the sending, by the first network element, the first information to a read/write device comprises:
when the read/write device is a terminal device, sending, by the first network element, the first information to the read/write device through a Non-Access Stratum (NAS) connection of the terminal device, or sending, by the first network element, the first information through a NAS connection of the Internet of Things device, wherein the NAS connection of the Internet of Things device is established by the terminal device for the Internet of Things device; or
when the read/write device is a base station, sending, by the first network element, the first information to the read/write device through a NAS connection of the Internet of Things device, wherein the NAS connection of the Internet of Things device is established by the base station for the Internet of Things device.

9. The method according to claim 1, wherein the first control request message comprises at least one of the following:
area information of an area in which the Internet of Things device is located;
a device service identifier of the Internet of Things device;
a device group service identifier corresponding to the Internet of Things device;
control type information corresponding to the first control;
a cycle of the first control; or
a frequency of the first control.

10. The method according to claim 1, wherein the first information comprises at least one of the following:
device control information;
a device control type;
device identifier information of the Internet of Things device;
a sending cycle of the device control information;
a sending frequency of the device control information; or
a device control transaction identifier, wherein the device control transaction identifier is used for marking a device control process corresponding to the first information, wherein
the device control information is used for at least one of the following:
obtaining the identifier information of the Internet of Things device, or
performing the first control on the Internet of Things device.

11. The method according to claim 10, wherein the device control information is encapsulated based on the specific communication protocol for communication between the Internet of Things device and the first network element.

12. The method according to claim 10, wherein the device control information is information encrypted by using a preconfigured key.

13. The method according to claim 10, wherein the device control information comprises at least one of the following:
a control type corresponding to the device control information,
a security parameter corresponding to the device control information,
a read parameter corresponding to the device control information,
a write parameter corresponding to the device control information,
write parameter content corresponding to the device control information,
a control cycle of the device control information, or
a control frequency of the device control information.

14. The method according to claim 1, wherein after the sending, by the first network element, first information, the method further comprises:
receiving, by the first network element, a first device control response, wherein
the first device control response comprises at least one of the following:
a result of processing the device control information by the Internet of Things device,
a cause value corresponding to the device control information,
a write result corresponding to the device control information,
the sending cycle of the device control information,
the sending frequency of the device control information, or
the identifier information of the Internet of Things device.

15. The method according to claim 14, wherein the first device control response is encapsulated through a specific communication protocol between the first network element and the read/write device; or the first device control response is encapsulated through the specific communication protocol between the Internet of Things device and the first network element.

16. A network element, comprising: a processor; and a memory, wherein the memory stores a program or instructions runnable on the processor, and the program or instructions, when executed by the processor, causes the processor to perform operations comprising:
receiving a first control request message, wherein the first control request message is used for requesting to perform first control on an Internet of Things device; and
sending first information,
wherein the first information is used for at least one of the following:
triggering obtaining identifier information of the Internet of Things device, or
triggering performing the first control on the Internet of Things device.

17. The network element according to claim 16, wherein sending the first information comprises:
sending the first information to a read/write device,
wherein a function of the first information comprises at least one of the following:
triggering the read/write device to obtain the identifier information of the Internet of Things device, or
triggering the read/write device to perform the first control on the Internet of Things device.

18. The network element according to claim 16, wherein the first control request message comprises at least one of the following:
area information of an area in which the Internet of Things device is located;
a device service identifier of the Internet of Things device;
a device group service identifier corresponding to the Internet of Things device;
control type information corresponding to the first control;
a cycle of the first control; or
a frequency of the first control.

19. The network element according to claim 16, wherein the first information comprises at least one of the following:
device control information;
a device control type;
device identifier information of the Internet of Things device;
a sending cycle of the device control information;
a sending frequency of the device control information; or
a device control transaction identifier, wherein the device control transaction identifier is used for marking a device control process corresponding to the first information,
wherein the device control information is used for at least one of the following:
obtaining the identifier information of the Internet of Things device, or
performing the first control on the Internet of Things device.

20. Anon-transitory computer-readable storage medium storing a program or instructions that, when executed by a processor, causes the processor to perform operations comprising:
receiving a first control request message, wherein the first control request message is used for requesting to perform first control on an Internet of Things device; and
sending first information,
wherein the first information is used for at least one of the following:
triggering obtaining identifier information of the Internet of Things device, or
triggering performing the first control on the Internet of Things device.
